(19) United States
(12) Patent Application Publication
(10) Pub. No.: US 2014/0165197 A1
(43) Pub. Date: Jun. 12, 2014

(54) MALWARE ATTACK PREVENTION USING BLOCK CODE PERMUTATION

(71) Applicant: EMPIRE TECHNOLOGY DEVELOPMENT, LLC, Wilmington, DE (US)

(72) Inventors: Shmuel Ur, Shorashim (IL); David Hirshberg, Haifa (IL); Mordehai Margalit, Zichron Yaaqov (IL); Vlad Grigore Dabija, Mountain View, CA (US); Shimon Gruper, Haifa (IL); Gad S. Sheaffer, Haifa (IL)

(21) Appl. No.: 13/976,661

(22) PCT Filed: Dec. 6, 2012
(86) PCT No.: PCT/US12/68115

§ 371 Date: Jan. 22, 2014

(51) Int. Cl. G06F 21/56

(52) U.S. Cl. CPC G06F 21/56
USPC 726/23

(57) ABSTRACT

Technologies are generally described for systems and methods configured to produce an executable code. In some examples, a developer may send machine language code to a system manager. The machine language code may include two or more machine language blocks and linking information. The system manager may include a processor configured to permute the machine language blocks to produce permuted machine language code. The processor may modify the linking information based on the permuted machine language code to produce modified linking information. The processor may link the permuted machine language code with use of the modified linking information to produce the executable code.

### BACKGROUND

Unless otherwise indicated herein, the materials described in this section are not prior art to the claims in this application and are not admitted to be prior art by inclusion in this section.

Malware, such as viruses and Trojan horses, may penetrate a system by exploiting code vulnerability. A piece of malware may find errors in code of an application and exploit those errors to use the application for alternate purposes. For example, malware may be used to cause a buffer overflow. In a buffer overflow, data may be written into a section of a memory where a designer of an application may not have originally intended data to be written. A hacker may be able to use this data written into memory and find means to cause the processor to process this data as an executable code in order to obtain some control over an application.

### SUMMARY

In some examples, a method for producing an executable code is generally described. The method may include, by a processor, receiving machine language code. The machine language code may include two or more machine language blocks. The method may include receiving linking information that relates to the machine language code. The method may include permuting the machine language blocks to produce permuted machine language code. The method may include modifying the linking information based on the permuted machine language code to produce modified linking information. The method may further include linking the permuted machine language code using the modified linking information to produce the executable code.

In some examples, a device configured to produce an executable code is generally described. The device may include a memory and a processor configured to be in communication with the memory. The processor may be configured to retrieve machine language code from the memory. The machine language code may include two or more machine language blocks. The processor may be configured to retrieve linking information from the memory. The linking information may relate to the machine language code. The processor may be configured to permute the machine language blocks to produce permuted machine language code. The processor may be configured to modify the linking information based on the permuted machine language code to produce modified linking information. The processor may further be configured to link the permuted machine language code with use of the modified linking information to produce the executable code.

In some examples, a system configured to produce an executable code is generally described. The system may include a first processor and a second processor configured to be in communication with the first processor. The first processor may be configured to receive a program. The first processor may be configured to compile the program to produce machine language code that includes two or more machine language blocks. The first processor may be configured to produce linking information that relates to the machine language code. The second processor may be configured to receive the machine language code. The second processor may be configured to receive the linking information. The second processor may be configured to permute the machine language blocks to produce permuted machine language code. The second processor may be configured to modify the linking information based on the permuted machine language code to produce modified linking information. The second processor may be configured to link the permuted machine language code with use of the modified linking information to produce the executable code.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement malware attack prevention using block code permutation;

FIG. 2 illustrates another example system that can be utilized to implement malware attack prevention using block code permutation;

FIG. 3 illustrates still another example system that can be utilized to implement malware attack prevention using block code permutation;

FIG. 4 depicts a flow diagram for an example process for preventing malware attacks using block code permutation;

FIG. 5 illustrates a computer program product that can be utilized to implement malware attack prevention using block code permutation; and

FIG. 6 is a block diagram illustrating an example computing device that is arranged to implement malware attack prevention using block code permutation; all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to preventing malware attacks using block code permutation.

Briefly stated, technologies are generally described for systems and methods configured to produce an executable code. In some examples, a developer may send machine language code to a system manager. The machine language code may include two or more machine language blocks and linking information. The system manager may include a processor configured to permute the machine language blocks to produce permuted machine language code. The processor may modify the linking information based on the permuted machine language code to produce modified linking information. The processor may link the permuted machine language code with use of the modified linking information to produce the executable code.

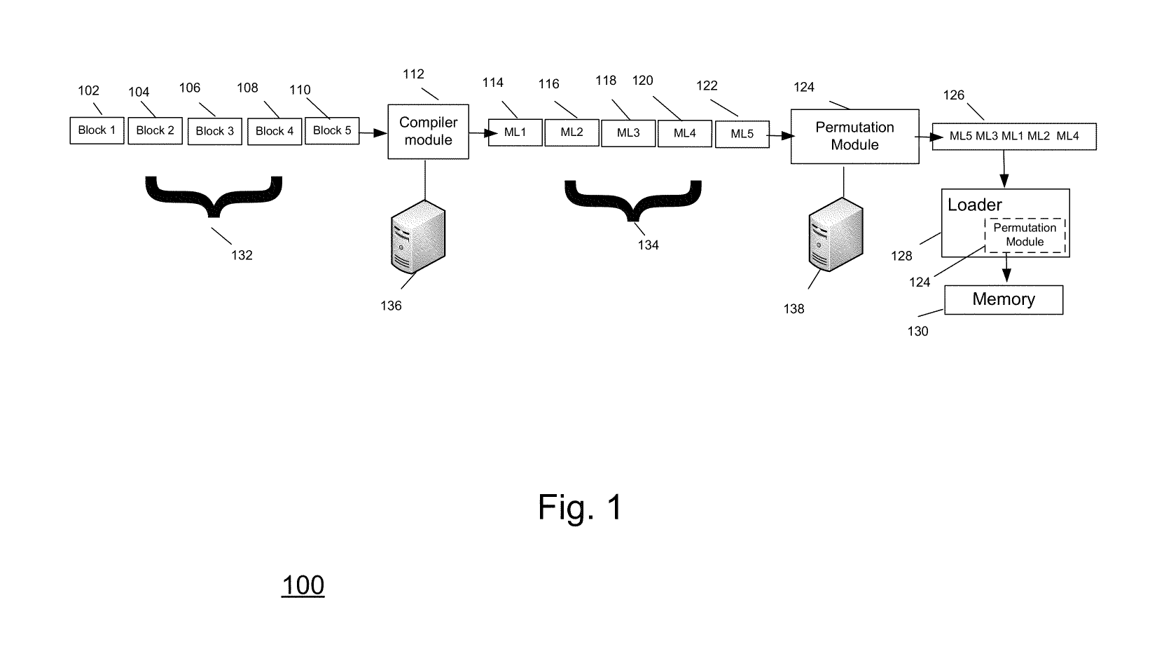

FIG. 1 illustrates an example system that can be utilized to implement malware attack prevention using block code permutation, arranged in accordance with at least some embodiments described herein. An example system 100 may include a compiler module 112, a permutation module 124 and/or a loader 128 arranged to be in communication with each other. Compiler module 112 may be hardware or implemented as a piece of software and executed by a processor 136. Permutation module 124 may be hardware or implemented as a piece of software and executed by a processor 138 or loader 128.

As explained in more detail below, compiler module 112 may receive a program 132 including two or more blocks 102, 104, 106, 108 and/or 110. Although five blocks are shown to simplify the discussion herein, program 132 may include any number of blocks. Compiler module 112 may compile blocks 102, 104, 106, 108, and/or 110 to produce machine language code 134 including two or more machine language blocks 114, 116, 118, 120 and/or 122. Machine language blocks may include objects produced by compiler module 112, parts of objects, libraries, or other machine code file produced by a compiler, etc. Permutation module 124 may receive machine language code 134 and permute an order of machine language blocks 114, 116, 118, 120 and/or 122 to produce a permuted machine language executable code 126. For example, permutation module 124 may load machine language blocks 114, 116, 118, 120 and/or 122 into a queue and then fetch machine language blocks 114, 116, 118, 120 and/or 122 from the queue in a different order. In another example, for M blocks, permutation module 124 may generate M pseudo random numbers corresponding to the number of blocks. Each random number may be assigned to an entry in a table having M entries. Permutation module 124 may then order blocks based on the corresponding number for the block in the table. Loader 128 may receive permuted machine language executable code 126 and load permuted machine language executable code 126 into a memory 130 for execution.

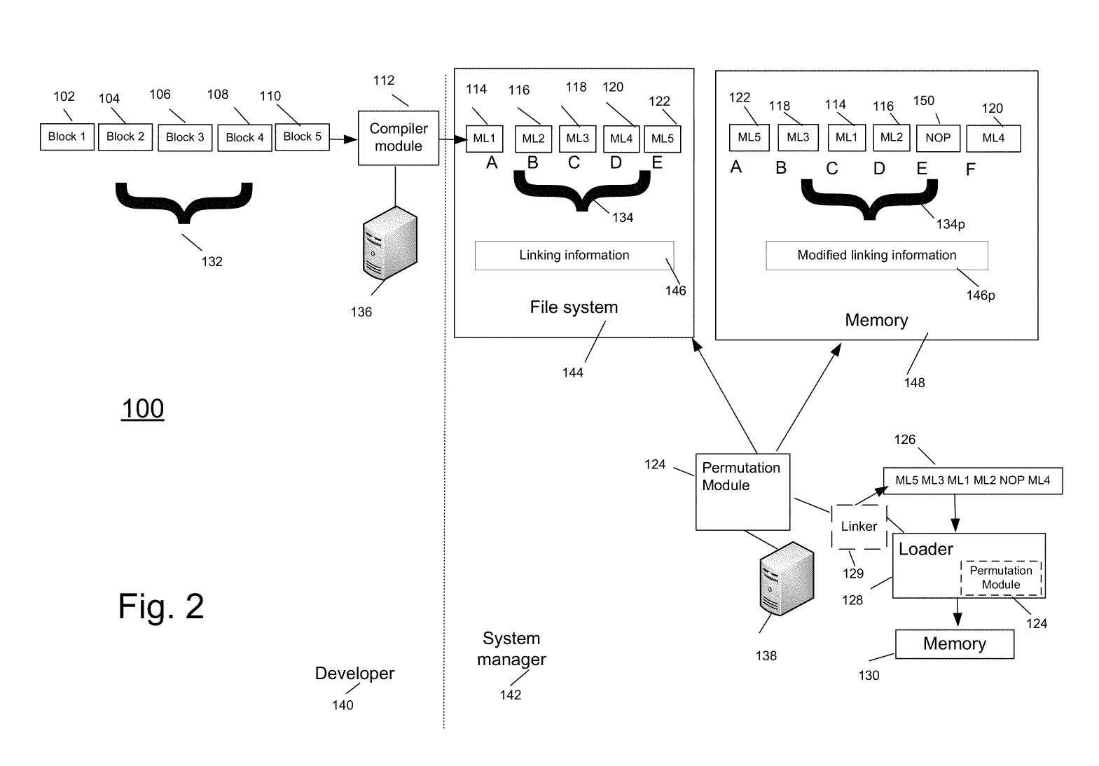

FIG. 2 illustrates another example system that can be utilized to implement malware attack prevention using block code permutation, arranged in accordance with at least some embodiments described herein. FIG. 2 is substantially similar to system 100, with additional details. Those components in FIG. 2 that are labeled identically to components of FIG. 1 will not be described again for the purposes of clarity.

Permutation module 124 may be implemented by processor 138 and/or by loader 128. For example, permutation may be performed prior to loading code into memory 130 or at the same time as loading the code into memory 130. In one example, a system manager 142 may receive machine language code 134 along with linking information 146 from a developer 140 Linking information 146 may provide information on how to link machine language blocks 114, 116, 118, 120, 122 to produce an executable code. For example, when machine language blocks 114, 116, 118, 120 and 122 are compiled, each machine language block may start with the same starting address of 0. Linking information 146 may assign different starting addresses for different machine language blocks based on an order to execute program 132. Further, when machine language blocks 114, 116, 118, 120 and 122 are compiled, calls to subroutines may be made using symbols Linking information 146 may resolve those symbols by identifying a location of the subroutine and adding object code relating to the subroutine. Some of the instructions in machine language blocks 114, 116, 118, 120 and 122 may include calls to libraries or other objects. Linking information 146 may provide information regarding calls to respective libraries and may add machine language code relating to those libraries. System manager 142 may store machine language code 134, including linking information 146, in a memory such as a file system 144.

In response to a request to execute program 132, permutation module 124 may retrieve machine language code 134 from file system 144 and store machine language code 134 in a memory 148. Machine language blocks are shown as being stored in memory locations A, B, C, D, and E. Permutation module 124 may permute machine language blocks 114, 116, 118, 120, 122 to change an order of machine language blocks 114, 116, 118, 120, 122 and produce a permuted machine language code 134p. Now, in memory 148, the machine language blocks are shown as being stored in different memory locations—along with a no operation block 150 discussed below. Similarly, permutation module 124 may modify linking information 146 based on permuted machine language code 134p to produce modified linking information 146p. After permuting machine language blocks 114, 116, 118, 120 and 122, permutation module 124 may further link the permuted machine language blocks 114, 116, 118, 120 and 122 using modified linking information 146p to produce permuted machine language executable code 126. Linking may be performed using a linker module 129. Linker module 129 may be part of permutation module 124 and/or loader 128 Linking, with modified linking information 146p, may resolve calls for objects in permuted machine language code 134p at locations that may have changed because of permuting machine language code 134. Permuting, linking and loading may be performed separately or at the same time by system 100.

In the example, machine language blocks are permuted to have the order 122, 118, 114, 116, no operation block 150, 120. Modified linking information 146p may provide instructions indicating that program 132 starts with machine language block 114—which now occupies the location C in memory 148. Modified linking information 146p may then indicate that program 132 moves forward in memory 148 to location D. Control may then jump to location B in memory 148, etc. When machine language block 120 finishes processing, modified linking information may indicate that processing should jump to memory location A for machine language block 122. Permutation module 124 may further add one or more no operation codes (“NOP”) 150, or other codes that do not affect permuted machine language code 134p, to permuted machine language code 134p to change a length of permuted machine language code 134p. Adding no operation code 150 may produce a modified permuted machine language code.

By permuting an order of machine language blocks 114, 116, 118, 120 and 122 in machine language code 134, an order of machine language blocks 114, 116, 118, 120 and 122 in machine language executable code 126 may change. The order of machine language blocks 114, 116, 118, 120 and 122 in machine language executable code 126 may be different for different requests for execution of program 132. However, because the linking information has been modified, the machine language blocks are still run in the same order.

Changing an order of machine language blocks 114, 116, 118, 120 and 122 in machine language executable code 126 may inhibit a producer of malware from gaining control of program 132 in memory 144. Adding no operation codes 150 may further change machine language executable code 126 further inhibiting a producer of malware from gaining control of program 132. Adding no operation codes 150 may change the footprint of executable code 126. However, permuting the order of the instructions may not yield changes in the function of program 132.

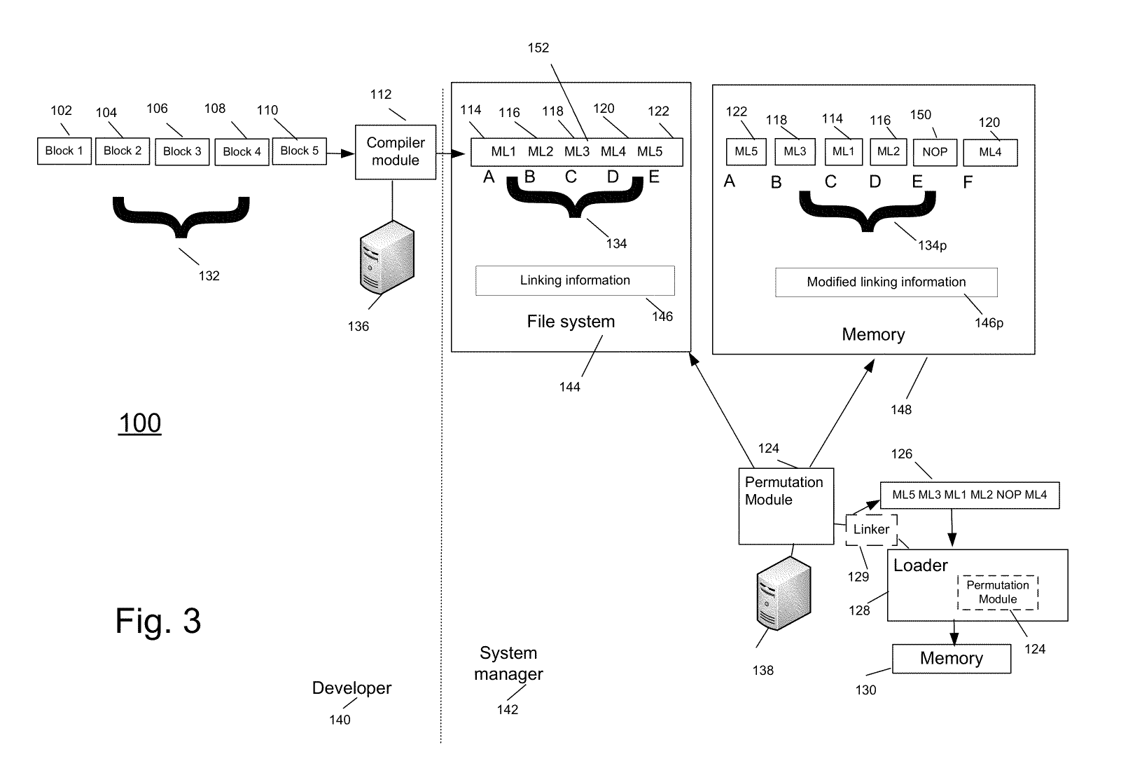

FIG. 3 illustrates still another example system that can be utilized to implement malware attack prevention using block code permutation, arranged in accordance with at least some embodiments described herein. FIG. 3 is substantially similar to system 100, with additional details. Those components in FIG. 3 that are labeled identically to components of FIGS. 1 and 2 will not be described again for the purposes of clarity.

In one example, developer 140 may compile and link blocks in program 132 to produce an executable code 152. System manager 142 may receive executable code 152 along with linking information 146 from compiler module 112. Permutation module 124 may analyze executable code 152 to identify machine language blocks 114, 116, 118, 120 and/or 122. For example, machine language blocks can be identified using linking information 146 that may define a start and end of each block. Once machine language blocks 114, 116, 118, 120 and/or 122 are identified, permutation module 124 may permute machine language blocks 114, 116, 118, 120 and/or 122 to produce permuted machine language code 134p.

In response to a request to execute program 132, permutation module 124 may retrieve executable code 152 from file system 144. Permutation module 124 may identify and permute machine language blocks 114, 116, 118, 120 and/or 122 to change an order of machine language blocks 114, 116, 118, 120, 122 and produce permuted machine language code 134p. Similarly, permutation module 124 may modify linking information 146 to produce modified linking information 146p.

Permutation module 124 may further link permuted machine language code 134p using modified linking information 146p to produce permuted machine language executable code 126. Permutation module 124 may further add one or more no operation codes (“NOP”) 150 to permuted machine language code 134p to change a length of permuted machine language code 134p. Adding no operation code 150 may produce a modified permuted machine language code.

Among other possible benefits, a system in accordance with the disclosure may make a program more difficult to be affected by malware. By way of example, if a piece of malware previously determined how to exploit an error in a program and implant malicious executable code in memory, the same blocks of the program may not be in the same location after permutation thereby making exploitation of the error more difficult. The same exploitation may not work because the blocks of the program may be in different locations. The exact location of code may not be ascertained by an attacker. The permutation and linking steps may have negligible degradation on system performance because they may be performed once upon initial loading of the program into memory. A system may move the linking process to the application loading process and linking may be performed differently for each request to execute a program.

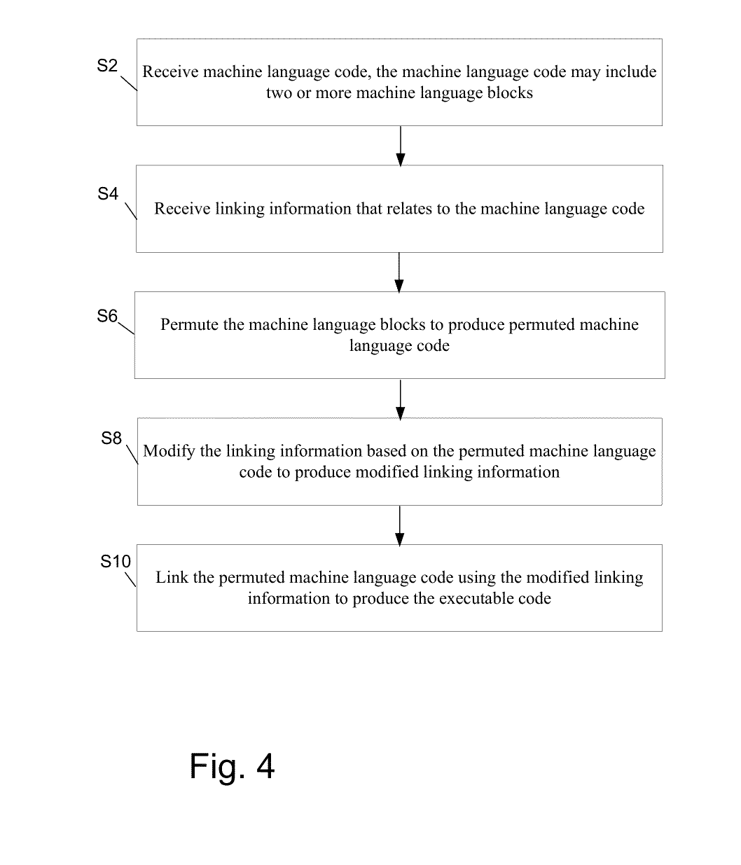

FIG. 4 depicts a flow diagram for an example process for preventing malware attacks using block code permutation, arranged in accordance with at least some embodiments described herein. In some examples, the process in FIG. 4 could be implemented using system 100 discussed above and may be used for producing an executable code.

An example process may include one or more operations, actions, or functions as illustrated by one or more of blocks S2, S4, S6, S8 and/or S10.

Processing may begin at block S2, “Receive machine language code, the machine language code may include two or more machine language blocks.” At block S2, a processor in a system manager may receive machine language code. The machine language code may include two or more machine language blocks. The machine language code may be linked so that the processor receives an executable code.

Processing may continue from block S2 to block S4, “Receive linking information that relates to the machine language code.” At block S4, the processor may receive linking information line that relates to the machine language code. The processor may receive the machine language code and the linking information in response to a request to execute a program.

Processing may continue from block S4 to block S6, “Permute the machine language blocks to produce permuted machine language code”. At block S6, the processor may permute the machine language blocks to produce a permuted machine language code. The blocks may be permuted into a different order for each request to execute the code.

Processing may also continue from block S6 to block S8, “Modify the linking information based on the permuted machine language code to produce modified linking information.” At block S8, the processor may modify the linking information based on the permuted machine language code to produce modified linking information.

Processing may continue from block S8 to block S10, “Link the permuted machine language code using the modified linking information to produce the executable code.” At block S10, the processor may link the permuted machine language code using the modified linking information to produce the executable code. The processor may add a no operation block to the permuted machine language code to produce a modified permuted machine language code. The processor may then link the modified permuted machine language code using the modified link information.

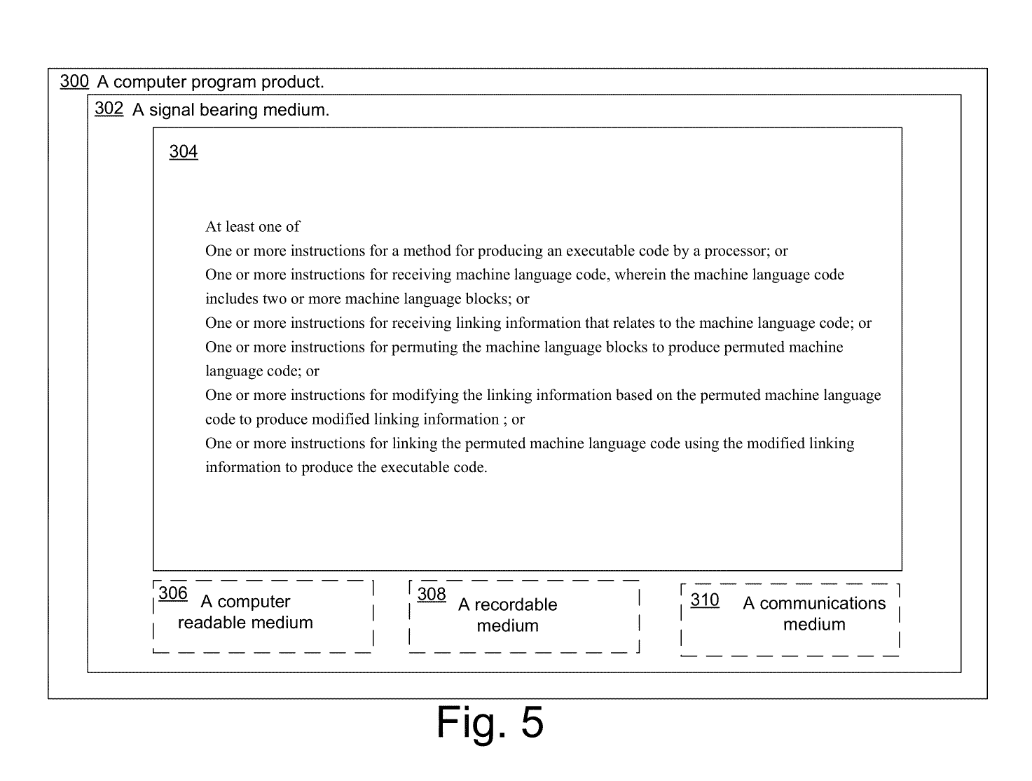

FIG. 5 illustrates an example computer program product 300 that can be utilized to implement malware attack prevention using block code permutation, arranged in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-4. Thus, for example, referring to system 100, permutation module 124 may undertake one or more of the blocks shown in FIG. 5 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

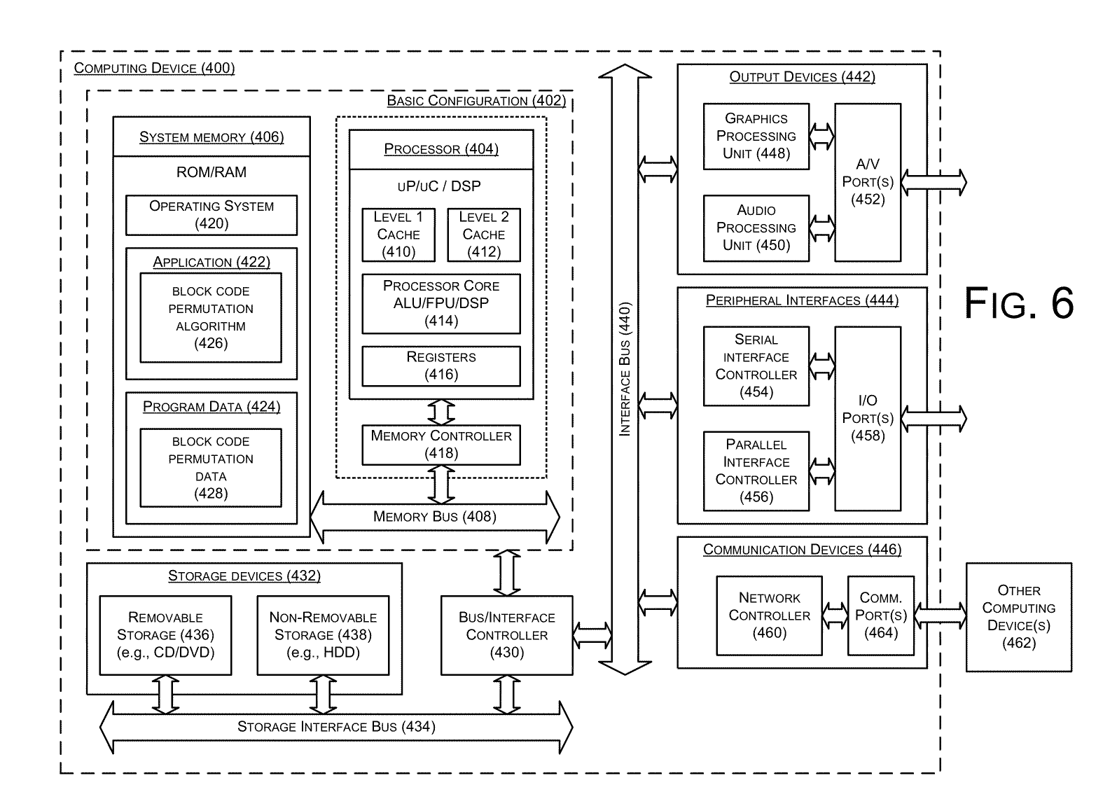

FIG. 6 is a block diagram illustrating an example computing device 400 that is arranged to implement malware attack prevention using block code permutation, arranged in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a block code permutation algorithm 426 that is arranged to perform the functions as described herein including those described with respect to system 100 of FIG. 1. Program data 424 may include block code permutation data 428 that may be useful to implement prevention of malware attacks using block code permutation as is described herein. In some embodiments, application 422 may be arranged to operate with program data 424 on operating system 420 such that prevention of malware attacks using block code permutation may be provided. This described basic configuration 402 is illustrated in FIG. 6 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,” a system having at least one of A, B, and C″ would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The following listing of claims replaces all prior listings of claims:

1. A method for producing an executable code, the method comprising, by a processor:
receiving machine language code, wherein the machine language code includes two or more machine language blocks;
receiving linking information that relates to the machine language code;
permuting the machine language blocks to produce permuted machine language code, wherein the permuted machine language code is different from the machine language code;
modifying the linking information based on the permuted machine language code to produce modified linking information; and
linking the permuted machine language code using the modified linking information to produce the executable code.

2. The method of claim 1, further comprising retrieving the machine language code and the linking information from a memory in response to a request to execute a program.

3. The method of claim 1, further comprising:
adding a no operation block to the permuted machine language code to produce a modified permuted machine language code; and
linking the modified permuted machine language code using the modified linking information to produce the executable code.

4. The method of claim 1, further comprising loading the executable code into a memory and executing the executable code.

5. The method of claim 1, further comprising:
in response to a first request to execute a program
permuting the machine language blocks to produce a first permuted machine language code, wherein the first permuted machine language code is different from the machine language code,
modifying the linking information based on the first permuted machine language code to produce a first modified linking information, and
linking the first permuted machine language code using the first modified linking information to produce a first executable code;
in response to a second request to execute the program
permuting the machine language blocks to produce a second permuted machine language code, wherein the second permuted machine language code is different from the first permuted machine language code and different from the machine language code,
modifying the linking information based on the second permuted machine language code to produce a second modified linking information, and
linking the second permuted machine language code using the second modified linking information to produce a second executable code, wherein the second executable code includes the machine language blocks in a different order than the first executable code.

6. The method of claim 1, further comprising receiving the machine language code, wherein the machine language code includes two or more linked machine language blocks.

7. The method of claim 1, further comprising:
receiving the machine language code;
wherein
the machine language code includes two or more linked machine language blocks;
the machine language blocks in the machine language code are linked; and
the method further includes
identifying the machine language blocks; and
permuting the machine language blocks to produce the permuted machine language code.

8. A device configured to produce an executable code, the device comprising:
a memory;
a processor configured to be in communication with the memory, wherein the processor is configured to:
retrieve machine language code from the memory, wherein the machine language code includes two or more machine language blocks;
retrieve linking information from the memory, wherein the linking information relates to the machine language code;
permute the machine language blocks to produce permuted machine language code, wherein the permuted machine language code is different from the machine language code;
modify the linking information based on the permuted machine language code to produce modified linking information; and
link the permuted machine language code with use of the modified linking information to produce the executable code.

9. The device of claim 8, wherein the processor is further configured to retrieve the machine language code and the linking information from a memory in response to a request to execute a program.

10. The device of claim 8, wherein the processor is further configured to:
add a no operation block to the permuted machine language code to produce a modified permuted machine language code; and
link the modified permuted machine language code with use of the modified linking information to produce the executable code.

11. The device of claim 8, further comprising a loader configured to load the executable code into a memory and execute the executable code.

12. The device of claim 8, wherein the processor is further configured to:
in response to a first request to execute a program
permute the machine language blocks to produce a first permuted machine language code, wherein the first permuted machine language code is different from the machine language code,
modify the linking information based on the first permuted machine language code to produce a first modified linking information, and
link the first permuted machine language code with use of the first modified linking information to produce a first executable code;
in response to a second request to execute the program
permute the machine language blocks to produce a second permuted machine language code, wherein the second permuted machine language code is different from the first permuted machine language code and different from the machine language code,
modify the linking information based on the second permuted machine language code to produce a second modified linking information, and
link the second permuted machine language code with use of the second modified linking information to produce a second executable code, wherein the second executable code includes the machine language blocks in a different order than the first executable code.

13. The device of claim 8, wherein the processor is configured to retrieve the machine language code, wherein the machine language code includes two or more linked machine language blocks.

14. The device of claim 8, wherein the processor is configured to:
retrieve the machine language code, wherein the machine language code includes two or more linked machine language blocks;
identify the machine language blocks; and
permute the machine language blocks to produce the permuted machine language code.

15. A system configured to produce an executable code, the system comprising:
a first processor, the first processor configured to:
receive a program,
compile the program to produce machine language code that includes two or more machine language blocks, and
produce linking information that relates to the machine language code;
a second processor configured to be in communication with the first processor, wherein the second processor is configured to:
receive the machine language code;
receive the linking information;
permute the machine language blocks to produce permuted machine language code, wherein the permuted machine language code is different from the machine language code;
modify the linking information based on the permuted machine language code to produce modified linking information; and
link the permuted machine language code with use of the modified linking information to produce the executable code.

16. The system of claim 15, wherein the second processor is configured to retrieve the machine language code and the linking information from a memory in response to a request to execute a program.

17. The system of claim 15, wherein the second processor is further configured to:
add a no operation block to the permuted machine language code to produce a modified permuted machine language code; and
link the modified permuted machine language code with use of the modified linking information to produce the executable code.

18. The system of claim 15, further comprising a loader configured to load the executable code into a memory and execute the executable code.

19. The system of claim 15, wherein the second processor is further configured to:
in response to a first request to execute a program
permute the machine language blocks to produce a first permuted machine language code, wherein the first permuted machine language code is different from the machine language code,
modify the linking information based on the first permuted machine language code to produce first modified linking information, and
link the first permuted machine language code with use of the first modified linking information to produce a first executable code;
in response to a second request to execute the program
permute the machine language blocks to produce a second permuted machine language code, wherein the second permuted machine language code is different from the first permuted machine language code and different from the machine language code;
modify the linking information based on the second permuted machine language code to produce second modified linking information; and
link the second permuted machine language code with use of the second modified linking information to produce a second executable code, wherein the second executable code includes the machine language blocks in a different order than the first executable code.

20. The system of claim 15, wherein the second processor is configured to:
retrieve the machine language code, wherein the machine language code includes two or more linked machine language blocks;
identify the machine language blocks; and
permute the machine language blocks to produce the permuted machine language code.
